(19) United States
(12) Patent Application Publication
(10) Pub. No.: US 2026/0194068 A1
(43) Pub. Date: Jul. 9, 2026

(54) HOLLOW MULTI CHAMBERED RADIAL WHEEL FOR A CHARGING SYSTEM

(71) Applicant: Accelleron Switzerland Ltd., Baden (CH)

(72) Inventors: Alessandro ZUCCHELLI, Baden (CH); Fabian GAFNER, Dürnten (CH); Matthew JAYARAMAN, Kidlington (GB)

(21) Appl. No.: 19/134,502

(22) PCT Filed: Dec. 7, 2023
(86) PCT No.: PCT/EP2023/084736

§ 371 Date: May 30, 2025

(30) Foreign Application Priority Data
Dec. 9, 2022 (EP) 22212593.2

(51) Int. Cl. F04D 29/28; F04D 17/10

(52) U.S. Cl. CPC F04D 29/284; F04D 17/10; F05D 2220/40; F05D 2230/31

(57) ABSTRACT

This disclosure provides a radial wheel having a rotational axis and a hub portion having an outer hub face defining a gas flow passage, the outer hub face being curved for radial gas flow so that a root-end portion of the outer hub face axially located at a root side is more radially outwardly arranged than a nose-end portion of the outer hub face axially located at a nose side. The radial wheel has further a plurality of blades extending radially outward from the hub portion into the gas flow passage, and an interior structure including a first chamber and a second chamber, a radial structure element being arranged axially between the first chamber and the second chamber and extending from the rotational axis radially outwards across the hub portion, and an axial structure element extending axially from the radial structure element across the first chamber.

### TECHNICAL FIELD

Embodiments of the present disclosure relate to a radial wheel for a charging system. Further, embodiments of the present disclosure relate to a charging system with such a radial wheel.

### BACKGROUND

Charging systems, in particular turbochargers, may be used for increasing the output of combustion engines. Usually, a turbine wheel may be arranged within an exhaust path of a combustion engine and a compressor wheel may be arranged upstream of the combustion engine. The exhaust gases generated by the combustion engine may expand in the turbine wheel. The extracted energy may be transferred by a shaft to the compressor wheel, which may compress air which is supplied to the engine. By utilizing the energy of the exhaust gases to compress the air supplied to the combustion process in the combustion engine, the combustion process and the efficiency of the combustion engine may be optimized.

Typically, the compressor wheels and/or the turbine wheels of a charging system are embodied as a radial wheel. A radial wheel according to the present disclosure also means wheels having an axial flow component, commonly referred to as diagonal wheels. Radial wheels may include multiple layered blades resulting in a complex external geometry.

Radial compressor wheels and turbine wheels of charging systems may be loaded by high centrifugal forces. The performance characteristics of charging systems may be affected by weight and inertia properties of the compressor wheels and turbine wheels. The lifetime and fatigue limits of radial wheels may be dependent from the stability and the stiffness of the radial wheel.

Additive manufacturing may be used for manufacturing compressor wheels and/or turbine wheels. One negative contributing factor from additive manufacturing radial wheels is a poor trade-off between manufacturing associated costs, as, e.g., materials and printing time per part, and the components advantages, in particular when printing component structures which originally were designed and optimized for traditional manufacturing methods. Further, additive manufacturing may usually be less advantageous for large-scale components.

### SUMMARY

Aspects and advantages of the disclosure will be set forth in part in the following description, or may be obvious from the description, or may be learned through practice of the disclosure.

The present disclosure provides a radial wheel for a charging system and a charging system having such a radial wheel for increasing the performance of the charging system and/or reducing the manufacturing costs by reducing the weight and inertia properties of the radial wheel.

In one aspect, the disclosure provides a radial wheel for a charging system. The radial wheel has a rotational axis and a hub portion having an outer hub face which defines a gas flow passage. The outer hub face is curved for radial gas flow so that a root-end portion of the outer hub face axially located at a root side is more radially outwardly arranged than a nose-end portion of the outer hub face axially located at a nose side. Further, the radial wheel includes a plurality of blades extending radially outward from the hub portion into the gas flow passage and an interior structure. The interior structure has a plurality of chambers, including a first chamber and a second chamber. A radial structure element of the interior structure is arranged axially between the first chamber and the second chamber and extends radially outwards across the hub portion. The interior structure further includes at least one structure element extending axially from the radial structure element across the first chamber.

In another aspect, the disclosure provides a charging system having a radial wheel as disclosed herein.

The details of one or more aspects of the disclosure are set forth in the accompanying drawings and the description below. Other features, objects, and advantages will be apparent from the description and drawings, and from the claims.

### BRIEF DESCRIPTION OF DRAWINGS

A full and enabling disclosure of the present disclosure is set forth in the specification, which makes reference to the appended figures, in which:

FIG. 1 is a schematic cross-sectional view of a radial wheel according to embodiments.

FIG. 2 is a perspective view on the cross-section A-A of the radial wheel of FIG. 1.

FIG. 3 is a schematic cross-sectional view of a radial wheel according to some embodiments.

FIG. 4 is a schematic cross-sectional view of embodiments of a radial wheel.

### DETAILED DESCRIPTION

This disclosure generally relates to radial wheels, in particular radial compressor wheels and/or radial turbine wheels, for charging systems, in particular for turbochargers, which provide advantageous weight and inertia properties through an optimized interior structure. A radial wheel according to this disclosure absorbs axial forces partially through an axial structure element and absorbs radial forces and centrifugal forces partially through a radial structure element such that the radial wheel may be capable of withstanding high rotational speeds as well as high thermal loads and high structural loads. In some examples, the radial wheel has hollow blades.

Embodiments of the radial wheel according to this disclosure may particularly be suitable for use as a compressor wheel for industrial applications, in particular for charging systems for industrial applications. Some embodiments of the radial wheel according to this disclosure may be particularly suitable for use as a compressor wheel and/or a turbine wheel for a turbocharger. Embodiments of charging systems and/or radial wheels according to this disclosure may be suitable for use in the power generation industry, for large off-highway vehicles, for the railway industry and/or for the marine industry or similar.

In general, this disclosure describes a radial wheel for a charging system which has a rotational axis and a hub portion having an outer hub face defining a gas flow passage. Typically, the hub portion is arranged rotationally symmetric around the rotational axis. As used herein, the rotational axis corresponds to an axis around the radial wheel rotates. The term “axially” refers to a direction along the rotational axis and the term “radially” refers to a direction perpendicular to an axial direction. The term “radially inward” refers to a position closer to the rotational axis than a position “radially outward”. The outer hub face may be curved for a radial gas flow. As used herein, the term “radial gas flow” includes a mixed flow having a radial flow component and an axial flow component. The root-end portion of the outer hub face is axially located at a root side and may be more radially outwardly arranged and inclined than a nose-end portion of the outer hub face which is axially located at a nose side.

While the root-end portion of a compressor wheel is usually arranged upstream along a gas flow path of the charging system compared to the nose-end portion, the root-end portion of a turbine wheel is typically arranged downstream along a gas flow path of the charging system compared to the nose-end portion.

A plurality of blades extends radially outward from the hub portion into the gas flow passage. The hub portion of the radial wheel according to this disclosure includes further an interior structure. The interior structure has a plurality of chambers, in particular a plurality of hollow chambers. As used herein, the term “chamber” refers to a substantially hollow portion within the hub portion which may be delimited in all directions by a wall portion, wherein the wall portion may have one or more openings. The one or more openings may serve for manufacturing purposes and/or for further reducing weight of the radial wheel. The one or more openings may be arranged in a rotationally symmetrical manner.

The interior structure further includes a radial structure element and an axial structure element. As used herein, the term “radial structure element” refers to a structure element extending between any two points of the outer hub face and through the rotational axis wherein the radial structure element extends at least partially and/or sectionally in the radial direction. The radial structure element may be arranged axially between a first chamber and a second chamber. The radial structure element may extend radially outwards across the entire hub portion outwards to the outer hub face and through the rotational axis of the radial wheel. The radial structure element may extend substantially perpendicular to the rotational axis and/or at least sectionally angled and/or curved with respect to the radial direction. An upper face of the radial structure element may extend in a different manner than a lower face of the radial structure element. As used herein, the term “upper face” refers to a lower wall portion of the above chamber delimiting the chamber on the root side. Similarly, the term “lower face” may refer to an upper wall portion delimiting the lower chamber on the nose side. For example, the upper face may extend substantially perpendicular to the rotational axis across the hub portion while the lower face may be bowed or vice versa. In embodiments, a thickness of the radial structure element may be constant or may vary partially. In particular, the thickness of the radial structure element may be dependent from a radial position. The term “thickness”, as used herein, may refer to the axial distance between the upper face and the lower face at such positions where the upper face is arranged axially nose ward of the lower face. A midplane may be defined by the plane being arranged at the same distance from the upper face as from the lower face. The midplane may extend through the rotational axis.

The axial structure element may extend from the radial structure element and across an entire axial extension of the first chamber. The axial structure element may extend substantially axially and/or at least sectionally angled or curved with respect to the rotational axis. Preferably, the at least one axial structure element may extend from the radial structure element across the first chamber within a cylindrical area that has a diameter equal or smaller than a lowest diameter of the outer hub face. The axial structure element may include a plurality of sub-elements.

As used herein, the term “across an entire axial/radial extension” refers to an extension between any two points being positioned substantially mutually opposite to each other along the axial/radial direction wherein the term “substantially” refers to an extension which may be angled to the axial/radial direction such that the two points may be offset from each other with respect to the respective direction.

The plurality of chambers being arranged in the hub portion may be arranged in an axially stacked manner. For high rotational speeds as well as high structural loads acting on the radial wheel, it may be suitable to provide a higher number of chambers. A higher number of substantially radially arranged structure elements may be provided for subdividing a hollow space into, e.g., two axially stacked chambers. Radially arranged structure elements, such as the radial structure element, may be suitable for absorbing centrifugal forces and for providing stiffness.

The interior structure may be formed such that a main inertia axis corresponds to the rotational axis of the radial wheel. In particular, each element, such as the radial structure element and the axial structure element, may be formed such that a main inertia axis corresponds to the rotational axis of the radial wheel. In embodiments, a discrete rotationally symmetric arrangement of single elements of the interior structure may be formed such that a main inertia axis corresponds to the rotational axis of the radial wheel. According to embodiments, different elements of the interior structure may mutually have a main inertia axial corresponding to the rotational axis of the radial wheel while each of these different elements may not necessarily have a main inertia axis corresponding to the rotational axis of the radial wheel.

In embodiments, single elements of the interior structure, such as the radial structure element and/or the axial structure element, may be formed in dependence on a number of blades arranged on the hub portion. For example, the plurality of blades may include 8 blades extending radially outward from the hub portion such that single elements and/or sub-elements of the interior structure may be arranged by discrete angles as integer multiples or integer fractions of 45°. In some embodiments, the plurality of blades may include 9 blades extending radially outward from the hub portion such that single elements and/or sub-elements of the interior structure may be arranged by discrete angles as integer multiples of 40°. Such embodiments may increase the running smoothness of the radial wheel. In some embodiments, with respect to vibration modes, it may be beneficial to avoid such dependencies.

According to embodiments, the radial structure element may extend, for example in at least one cross-section containing the rotational axis, continuously between two mutually opposite circumferential positions across the hub portion. Preferably, the radial structure element may extend in a plurality of cross-sections containing the rotational axis between any two mutually opposite circumferential positions. Particularly preferably, the radial structure element may extend in any cross-section containing the rotational axis between any two mutually opposite circumferential positions. Such designs may enable the radial wheel to withstand high rotational speeds. As used herein, the term “extends continuously” refers to a structure along a continuous path between the mutually opposite circumferential positions, e.g., through the radial structure element. Preferably, in a respective cross-section containing the rotational axis and the respective mutually opposite circumferential positions.

In embodiments, the plurality of chambers of the interior structure may include at least one chamber being arranged within at least one of the plurality of blades of the radial wheel. Providing a substantially hollow blade may improve the inertia properties of the radial wheel.

According to some embodiments, a lattice structure may be arranged within at least one of the plurality of chambers. In particular, the lattice structure may permeate at least 60%, preferably at least 70%, particularly preferably at least 80% of a volume of the respective chamber. As used herein, a lattice structure permeating at least 60% of a volume of the respective chamber is defined by 60% of an inner volume of the respective chamber is spaced apart from the lattice structure by at most a characteristic length. The characteristic length may be defined by a lattice constant of the lattice structure. The lattice structure may enable lower wall thicknesses of, e.g., the axial structure element and/or the radial structure element. The lattice structure may enable a lower weight of the radial wheel and improved inertia properties. The lattice structure may serve as a supporting structure.

In some embodiments, a third chamber may be arranged axially at a root side of the first chamber and the second chamber and/or a fourth chamber may be arranged axially at a nose side of the first chamber and the second chamber. Subdividing the hollow hub portion in a plurality of axially stacked chambers may enable the radial wheel to withstand higher centrifugal forces while the weight may be reduced and the inertia properties may be improved.

According to embodiments, at least one of the plurality of chambers may be connected to another one of the plurality of chambers. In embodiments, each of the plurality of chambers may be connected to each other. As used herein, the term “connected” refers to a connection through a path between two positions that can be passed by a powder, e.g. a powder used for additive manufacturing, in a direct or indirect manner. For example, the first chamber may be indirectly connected to the fourth chamber through a direct connection of the first chamber to the second chamber and another direct connection from the second chamber to the fourth chamber or vice versa. The plurality of chambers may, e.g., be connected to each other by the one or more openings in the surrounding wall portions. Such embodiments may facilitate manufacturing the radial wheel.

In some embodiments, the interior structure may have a plurality of radial spokes which radial spokes may connect a nose side of the radial structure element to a radially outer surface of the chamber. In particular, the radial spokes may extend from the nose side of the radial structure element radially outward and axially towards the nose. In embodiments, the radial structure element may be directly connected to the outer hub face at an axial position closer to the root-end than the plurality of radial spokes. In some embodiments, the plurality of spokes may include a number of spokes that is an integer multiple or an integer fraction of the number of the blades extending radially outwards from the hub portion. The plurality of radial spokes may absorb and/or direct partially centrifugal forces into the radial structure element acting at an axial position closer to the nose-end than the axial position of the nose-side of the radial structure element. The plurality of radial spokes may increase the stability and stiffness of the radial wheel.

According to embodiments, the first chamber may be arranged substantially at an axial level of a widest radius of the hub portion and/or the second chamber may be arranged closer to the nose side than the first chamber. As used herein, the term “axial level of a widest radius of the hub portion” refers to a widest radius section on the rotational axis which widest radius section may have the largest radial distance to the hub portion. The widest radius section may include a center point or may be a point on the rotational axis. The term “substantially at an axial level of a widest radius of the hub portion” may refer to an extended section on the rotational axis that is extended compared to the widest radius section. The extended section may have the same center point as the widest radius section and may extend from the center point, or alternatively from the point, at most 10% of an axial extension of the hub portion in each of both directions on the rotational axis more than the widest radius section. The term “the first chamber being arranged substantially at an axial level of a widest radius of the hub portion”, as used herein, refers to a design wherein any portion of the first chamber may be arranged within a radially extended area of the extended section. Such embodiments, may improve the inertia properties of the radial wheel while a high stability and stiffness may be provided.

In some embodiments, the radial structure element may have a non-planar lower face. An upper face of the radial structure element may be non-planar. In particular, the lower face and/or the upper face may be formed curved root-wardly from a direction radially inwards to outwards and/or may protrude nose-wardly in a radially inner portion.

In embodiments, the radial structure element may be formed based on a ratio between two parameters. For example, the thickness of the radial structure element may be formed according to an upper thickness-diameter ratio or to a lower thickness-diameter ratio. As used herein, the “diameter” of the upper thickness-diameter ratio may be defined by the largest radial extension of the upper face of the radial structure element. Similarly, the “diameter” of the lower thickness-diameter ratio may be defined by the largest radial extension of the lower face of the radial structure element. The upper thickness-diameter ratio and/or the lower thickness-diameter ratio may be between 0.01 and 0.40, preferably between 0.05 and 0.22, and particularly preferably between 0.01 and 0.18.

According to embodiments, at least one sub-element of the axial structure element may be formed rotationally symmetric about the rotational axis. In embodiments, the axial structure element may be discrete symmetric with respect to rotation only by discrete angles such as integer multiples of about 30°, preferably by discrete angles that may be dependent from the number of blades extending radially outward from the hub portion.

In some embodiments, the axial structure element may be supported at its root side for absorbing an axial load, such as a tensile load and/or a compressive load.

According to embodiments, a material ratio of the radial wheel may be between 30% and 70%, preferably between 40% and 60%, particular preferably between 45% and 55%. As used herein, the term “material ratio” refers to a percentage of material arranged within a predefined volume. For example, a solid body may have a material ratio of 100%.

In embodiments, the radial wheel may be integrally formed by a layer-by-layer process. In particular, the radial wheel may be integrally formed by a layer-by-layer process from one or more powders, such as from one or more kinds of metal powder.

According to embodiments, the radial wheel may be a radial compressor wheel. In some embodiments, the radial wheel may be an open wheel, i.e. a radial wheel that does not include a shroud. In embodiments, the blades may be attached with their base to the hub, but otherwise unconnected, and in particular not connected to each other by a shroud.

Reference now will be made in detail to embodiments of the disclosure, some examples of which are illustrated in the drawings. Each example may be provided by way of explanation of the disclosure, not limitation of the disclosure. For instance, features illustrated or described as part of embodiments may be used with other embodiments to yield still further embodiments. The drawings may not be true-to-scale.

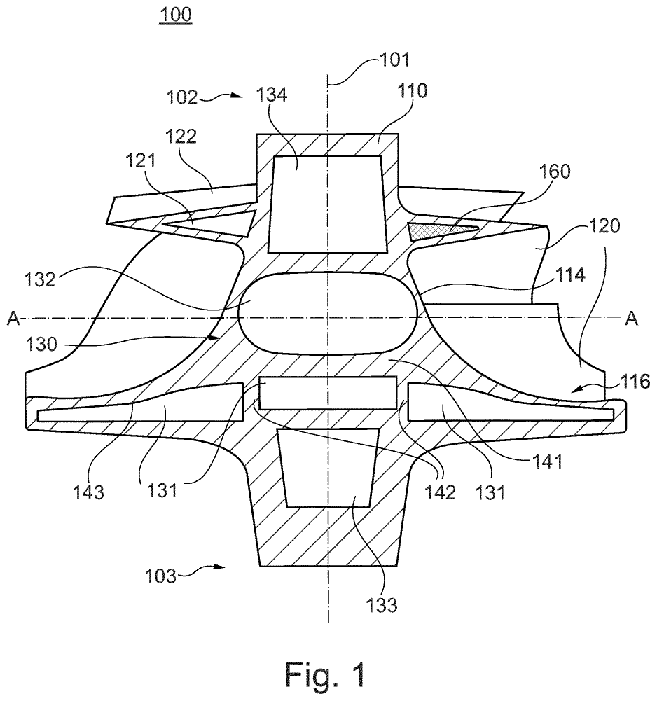

FIG. 1 shows a schematic cross-sectional view of a radial wheel 100 according to embodiments of this disclosure. The radial wheel 100 may be radial compressor wheel or a radial turbine wheel.

The radial wheel 100 may be used for a charging system, in particular for a turbocharger. According to embodiments, the radial wheel 100 may include a connection means at a root side 103 for mounting the radial wheel 100 on a shaft of the charging system. In embodiments, the radial wheel 100 may have a shaft. In embodiments, a tube, rotating around a rotational axis 101 of the radial wheel 100, may be arranged partially through the radial wheel 100 for mounting the radial wheel 100 on a shaft by a fixation means or a like. The tube may be included by the radial wheel 100.

The radial wheel 100 may have a hub portion 110 which includes an outer hub face 114. A gas flow passage 116 may be defined by the outer hub face 114. The hub portion 110 may comprise a larger diameter at the root side 103 than at a nose side 102 of the radial wheel. The outer hub face 114 may be curved for radial gas flow and/or diagonal gas flow.

The radial wheel 100 may include a plurality of blades 120 which may be arranged on the outer hub face 114. The plurality of blades 120 may extend radially outward from the hub portion 110 into the gas flow passage 116. The radial wheel 100 may be an open wheel so as the radial wheel 100 does not include a shroud.

In embodiments, the radial wheel 100 has a partially hollow interior structure 130. Preferably, the interior structure 130 may be substantially hollow. For example, the radial wheel 100 may have a material ratio of less than 60%, preferably less than 55%, particularly preferably less than 50% compared to a solid radial wheel having the same external geometry due to the partially hollow interior structure 130.

The interior structure 130 may, e.g., be defined by a plurality of chambers, such as by a first hollow chamber 131 and a second hollow chamber 132. The chambers may be delimited in all directions by a wall portion. The delimited space by the wall portion(s) may be hollow. The plurality of chambers may be formed in different designs such as a cuboid, a sphere or any other design, for example one or more chambers may be at least partially delimited by wall portions of even wall thickness of the hub portion 110 such that the design of the one or more chambers may be at least partially dependent from the geometry of the outer hub face 114. In embodiments, the wall portion may have one or more openings.

The interior structure 130 may include a third chamber 133 and a fourth chamber 134. The third chamber 133 may be arranged axially at a root side 103 of the first chamber 131. The fourth chamber 134 may be arranged axially at a nose side 102 of the second chamber 132.

The plurality of blades 120 may further include at least one blade chamber 121. The blade chamber 121 may be arranged in a blade 122. In embodiments, the blade chamber 121 may be formed at least partially according to a geometry of the blade 122, in particular such, that the blade 122 may resemble a shell with even wall thicknesses.

In embodiments, the wall portion delimiting one or more of the plurality of chambers may have openings. In particular, as shown in FIG. 1, the second chamber 132 and the fourth chamber 134 may be partially delimited by the same wall portion. The wall portion being arranged axially between the second chamber 132 and the fourth chamber 134 may have one or more openings such that the second chamber 132 and the fourth chamber 134 may be directly connected. According to embodiments, any of the plurality of chambers may be connected to any other of the plurality of chambers. The connection may be direct or indirect. In particular, the first chamber 131 may be indirectly connected to the fourth chamber 134 by being connected directly to the second chamber which in turn may be directly connected to the fourth chamber 134.

The interior structure may further include additional chambers. For example, the fourth chamber may be divided by a wall portion in two or more chambers. By providing additional chambers, the material ratio of the radial wheel 100 will have a higher percentage value than by providing a smaller number of chambers. While a higher percentage value of material ratio may increase the stiffness of the radial wheel and be capable of absorbing a higher amount of acting forces, more material may have to be accelerated during operation of the radial wheel 100 which may result in a higher amount of acting forces and/or more disadvantageous inertia properties.

Axially between the first chamber 131 and the second chamber 132 a radial structure element 141 may be arranged. The radial structure element 141 may extend substantially perpendicular to the rotational axis 101. In embodiments, the radial structure element 141 may extend radially outwards across the hub portion 110 and through the rotational axis 101. The radial structure element 141 may absorb circumferential forces during operating of the radial wheel 100.

The radial structure element 141 may extend in a plurality of cross-sections containing the rotational axis 101 continuously between two mutually opposite circumferential positions across the hub portion 110. The plurality of cross-sections containing the rotational axis 101 may be angled with respect to each other by an integer multiple of 15°. Preferably, the radial structure element 141 may extend in any cross-section containing the rotational axis 101 between any two mutually opposite circumferential positions.

In embodiments, the radial structure element 141 may be formed according to an upper thickness-diameter ratio and/or a lower thickness-diameter ratio. The upper thickness-diameter ratio and/or the lower thickness-diameter ratio may be between 0.01 and 0.40, preferably between 0.05 and 0.22, and particularly preferably between 0.01 and 0.18. The thickness of the radial structure element 141 may be selected according to the axial position and/or in dependence on the radial extension of the radial structure element 141.

According to embodiments, the first chamber 131 may be arranged substantially at an axial level of a widest radius of the hub portion 110. Since the radial structure element 141 may be arranged at a nose side 102 of the first chamber 131, the radial structure element 141 may be in a beneficial position for absorbing a high amount of circumferential forces.

The radial structure element 141 may have a non-planar lower face. In particular, the radial structure element 141 may be bowed with from the rotational axis growing radial position toward the root side 103. An upper face of the radial structure element 141 may be formed non-planar. In particular, the upper face of the radial structure element 141 may be formed curved nose-wardly from radially inwards to radially outwards.

As shown in FIG. 1, an axial structure element 142 may extend across the first chamber 131 substantially axially. The axial structure element 142 may be designed as one or more columns, e.g. each representing a sub-element of the axial structure element, as a cylinder or alike. During operation, the axial structure element 142 may absorb axial forces acting on the radial wheel 100. In embodiments, the axial structure element 142 may extend sectionally in the radial direction. Preferably, the axial structure element 142 may be designed rotationally symmetric about the rotational axis 101. In embodiments, also a discrete rotationally symmetric design of a plurality of sub-elements of the axial structure elements 142 may be formed, for example, by integer multiples of 30°.

For example, in order to absorb a high amount of tensile and/or compressive axial forces, it may be beneficial to provide a support at the root side of the axial structure element 142.

The radial wheel 100 as shown in FIG. 1 may be integrally formed by a layer-by-layer process. In particular, the radial wheel 100 may be formed from a powder. The powder may be a metal powder. For example, if a radial compressor wheel is formed, a titanium alloy powder and/or an aluminum alloy powder may be used. When forming a turbine wheel, typically a nickel alloy powder may be used. The radial wheel 100 may, e.g., be manufactured by a selective laser melting process or alike.

In some embodiments, the radial wheel 100 may be integrally formed by the layer-by-layer process from a plurality of materials. For example, highly stressed areas of the radial wheel 100 may be printed using a different material, for example a high strength metal alloy, than low stressed areas of the radial wheel 100. In some embodiments, the material may be at least partially selected in dependence on the radial position and/or the axial position. For example, highly heat conductive materials, such as copper, may be selected for areas, elements of the interior structure 130 and/or sub-elements of the interior structure 130 near to the rotational axis 101.

In embodiments, support structures may be used for printing the radial wheel 100. According to embodiments, a lattice structure 160 may be used as a support structure. The lattice structure 160 may be arranged in one or more of the plurality of chambers. In particular, the lattice structure 160 may permeate at least 80% of the volume of the respective chamber. The inner volume of the respective chamber is spaced apart from the lattice by at most a characteristic length of the lattice structure 160.

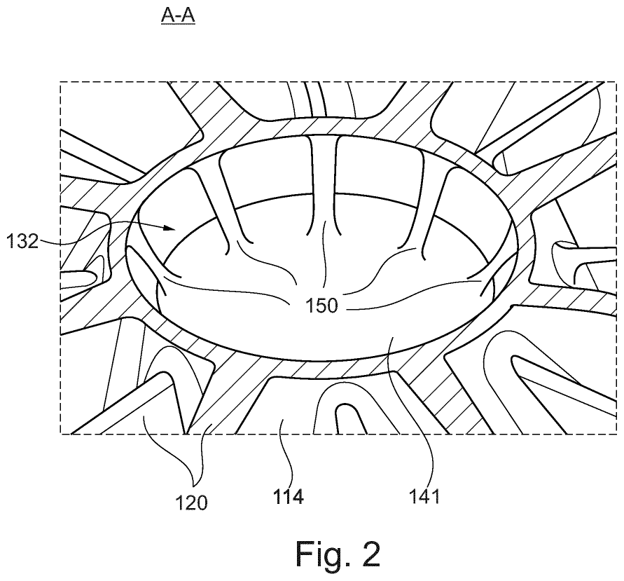

FIG. 2 shows a schematic perspective view on the cross-section A-A of the radial wheel 100 of FIG. 1. FIG. 2 shows the plurality of blades 120 that may extend radially outward from the outer hub face 114. Further, the second chamber 132 is shown in a perspective cross-sectional view. The wall portion delimiting the second chamber on the root side 103 may be an upper face of the radial structure element 141.

According to embodiments, a plurality of radial spokes 150 may be arranged in the second chamber 132. The plurality of radial spokes 150 may connect the radial structure element 141 to a radially outer surface of the second chamber 132. For example, the radial spokes 150 may extend from the nose side of the radial structure element 141 radially outward and axially towards the nose side 102, as exemplarily shown in FIG. 2. Similarly, the plurality of radial spokes 150 may additionally or alternatively be arranged in any other of the plurality of chambers. Further, the plurality of radial spokes 150 may additionally and/or alternatively be arranged between the first chamber 131 and the third chamber 133 and/or between the second chamber 132 and the fourth chamber 134 such that an opening may be provided between any of the plurality of radial spokes 150 which may connect the two respective chambers directly to each other.

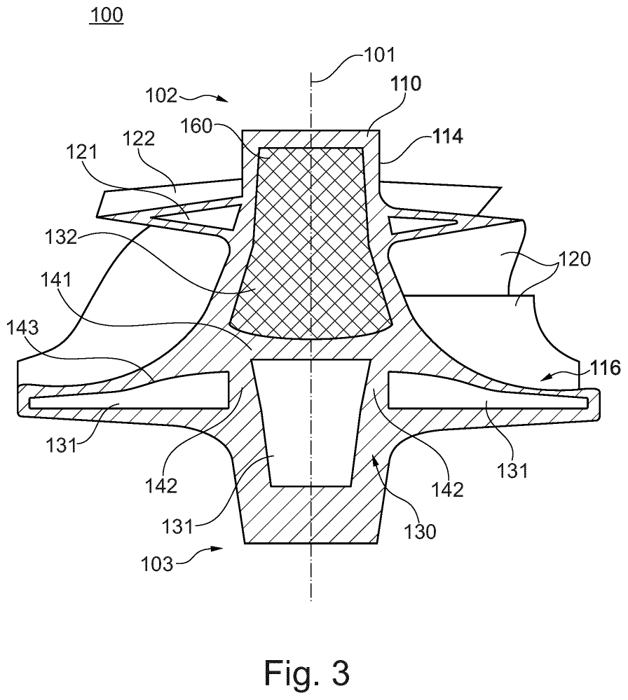

FIG. 3 shows a schematic cross-sectional view of a radial wheel 100 according to some embodiments. The radial wheel 100 may have a hub portion 110 and a plurality of blades 120 rotating around a rotational axis 101. The hub portion 110 may include an interior structure 130 that may include a plurality of chambers. The interior structure 130 of the radial wheel 100 in FIG. 3 includes a first chamber 131, a second chamber 132 and a plurality of blade chambers 121.

A radial structure element 141 may be arranged axially between the first chamber 131 and the second chamber 132. The radial structure element 141 may extend less in the axial direction than in the radial direction. A lower face 143 of the radial structure element 141 may be curved such that the radial structure element 141 may extend to a widest diameter of the hub portion 110. The radial structure element 141 may include openings. In particular, the radial structure element 141 may include a plurality of bars being arranged angled to each other. For example, each bar of the plurality of bars may extend across the entire hub portion 110. Between each two bars, an opening may be formed. Each bar of the plurality of bars may extend between a first position and a second position. The second position may correspond to that of the first position when rotated around the rotational axis 101 by 180°. In some embodiments, the radial structure element 141 may be formed continuous and without any opening.

A cylindrical axial structure element 142 may be arranged extending from the radial structure element 141 across the first chamber 131 within a cylindrical area that may have a diameter which may be equal or smaller than the smallest diameter of an outer hub face 114. In some embodiments, a plurality of sub-elements of the axial structure element 142 may be arranged in a discrete rotationally symmetric manner. In particular, in an annular pattern, one sub-element of the axial structure element 142 may be arranged at each 15° or at each multiple integer of 15°. The sub-element may have a circular cross-section.

A lattice structure 160 may be arranged in the second chamber 132. The lattice structure 160 may enable extended dimensions of hollow chambers, such as the second chamber 132. The lattice structure 160 may improve the inertia properties of the radial wheel inter alia since a wall thickness of the hub portion 110 may be reduced and forces that would otherwise have to be absorbed by the outer wall of the hub portion 110 may be absorbed by the lattice structure 160 in a radial position closer to the rotational axis 101.

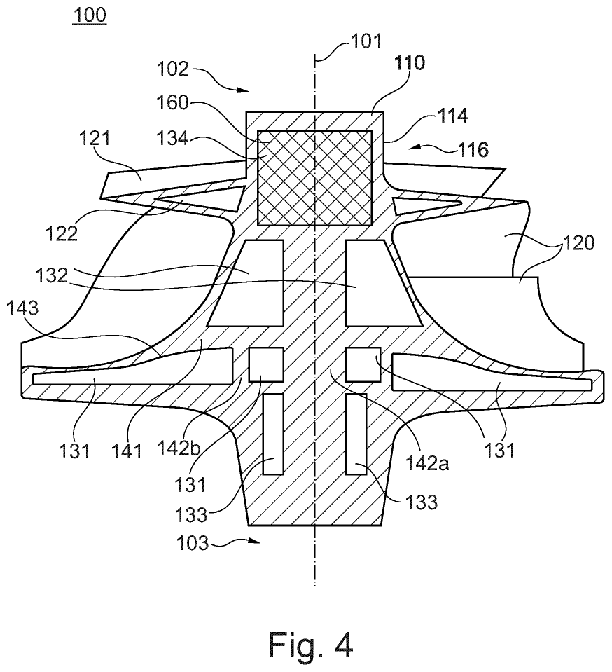

FIG. 4 shows a schematic cross-sectional view of embodiments of a radial wheel 100. The radial wheel 100 may have an interior structure 130 including a first chamber 131, a second chamber, 132, a third chamber 133, a fourth chamber 134 and blade chambers 121 in each of a plurality of blades 120 extending radially outward from a hub portion 110 of the radial wheel.

The interior structure 130 shown in FIG. 4 may include a radial structure element 141. Further, the interior structure 130 may include an axial structure element 142 having a plurality of sub-elements. A first sub-element 142a may be formed as a column from the radial structure element 141 across the entire first chamber 131, third chamber 133 and second chamber 132 along the rotational axis 101. A cylindrical second sub-element 142b may be formed around the rotational axis 101 across the first chamber 131.

A lattice structure 160 may be formed in the fourth chamber 134 and/or in any other of the plurality of chambers. The lattice structure 160 may serve as a support structure for integrally forming the radial wheel 100. For example, the radial wheel 100 may be formed layer-by-layer by a 3D-printer. The lattice structure 160 may serve as the support structure and may remain in the chamber during operation of the radial wheel 100.

Any of the embodiments of the radial wheel may be implemented to a charging system according to this disclosure, for example as a radial compressor wheel and/or as a turbine wheel.

Thus, a radial wheel has been presented in the foregoing description with reference to specific examples. It is to be understood that various aspects disclosed herein may be combined in different combinations than the specific combinations presented in the accompanying drawings. It is appreciated that various modifications to the referenced examples may be made without departing from the scope of the disclosure and the following claims.

### LIST OF REFERENCE NUMBERS

100 radial wheel
101 rotational axis
102 nose side
103 root side
110 hub portion
114 outer hub face
116 gas flow passage
120 plurality of blades
121 blade chamber
122 blade
130 interior structure
131 first chamber
132 second chamber
133 third chamber
134 fourth chamber
141 radial structure element
142 axial structure element
142a first sub-element
142b second sub-element
143 lower face
150 plurality of radial spokes
160 lattice structure

1. A radial wheel for a charging system, the radial wheel having a rotational axis and comprising:
a hub portion having an outer hub face defining a gas flow passage, the outer hub face being curved for radial gas flow so that a root-end portion of the outer hub face axially located at a root side is more radially outwardly arranged than a nose-end portion of the outer hub face axially located at a nose side;
a plurality of blades extending radially outward from the hub portion into the gas flow passage; and
an interior structure comprising:
a plurality of chambers, including a first chamber and a second chamber;
a radial structure element being arranged axially between the first chamber and the second chamber and extending from the rotational axis radially outwards across the hub portion; and
an axial structure element extending axially from the radial structure element across the first chamber.

2. The radial wheel according to claim 1, wherein the radial structure element extends continuously between two mutually opposite circumferential positions across the hub portion in at least one cross-section containing the rotational axis.

3. The radial wheel according to claim 1, wherein the plurality of chambers further comprises a blade chamber arranged in at least one of the blades.

4. The radial wheel according to claim 1, wherein the interior structure further comprises a lattice structure within at least one of the plurality of chambers.

5. The radial wheel according to claim 1, wherein the plurality of chambers further comprises a third chamber being arranged axially at a root side of the first chamber and the second chamber, and/or a fourth chamber being arranged axially at a nose side of the first chamber and the second chamber.

6. The radial wheel according to claim 1, wherein at least one of the plurality of chambers is connected to another one of the plurality of chambers, in particular wherein each of the plurality of chambers is connected to each other.

7. The radial wheel according to claim 1, wherein the interior structure further comprises a plurality of radial spokes connecting a nose side of the radial structure element to a radially outer surface of the second chamber, in particular wherein the radial spokes extend, from the nose side of the radial structure element, radially outward and axially towards the nose.

8. The radial wheel according to claim 1, wherein the first chamber is arranged substantially at an axial level of a widest radius of the hub portion, and/or wherein the second chamber is arranged closer to the nose side than the first chamber.

9. The radial wheel according to claim 1, wherein the radial structure element comprises a non-planar lower face.

10. The radial wheel according to claim 1, wherein the axial structure element is formed rotationally symmetric about the rotational axis.

11. The radial wheel according to claim 1, wherein the axial structure element is supported at its root side for absorbing an axial load.

12. The radial wheel according to claim 1, wherein the radial wheel comprises a material ratio of 30% to 70%, preferably the material ratio is between 40% and 60%, particularly preferably the material ratio is between 45% and 55%.

13. The radial wheel according to claim 1, wherein the radial wheel is integrally formed by a layer-by-layer process, in particular from one or more kinds of powder.

14. The radial wheel according to claim 1, wherein the radial wheel is a radial compressor wheel.

15. Charging system having the radial wheel according to claim 1.
